(19) United States
(12) Patent Application Publication
(10) Pub. No.: US 2007/0187195 A1
(43) Pub. Date: Aug. 16, 2007

(54) Glove box lamp switch

(76) Inventor: Woo Chul Park, Suwon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/529,464

(22) Filed: Sep. 27, 2006

(30) Foreign Application Priority Data
Feb. 16, 2006 (KR) 10-2006-0014892

(51) Int. Cl. F16F 9/00

(52) U.S. Cl. 188/321.11

(57) ABSTRACT

A glove box lamp switch is installed to a glove box damper including a damper cylinder at an end of which is connected to one side of an inner portion of an instrument panel and a damper piston is connected to one end of a glove box. The glove box damper is configured such that the total length varies depending on the opening and closing of the glove box and is filled with air so as to absorb an impact generated during opening and closing operations of the glove box of a vehicle. The glove box lamp includes a first terminal installed at one side of an interior of the damper cylinder and a semicircular shaped second terminal which installed to a stopping flange formed at one end of the damper piston thereby selectively contacting the first terminal by movement of the damper piston.

### CROSS-REFERENCE TO RELATED APPLICATION

This application claims priority to Korean Patent Application No. 10-2006-0014892 filed in the Korean Intellectual Property Office on Feb. 16, 2006, the disclosures of which are incorporated herein by reference.

### BACKGROUND OF THE INVENTION

(a) Field of the Invention

The present invention relates to a glove box lamp in a vehicle. In particular, the switch of a glove box lamp provides lights up the glove box lamp when a glove box of a vehicle is opened.

(b) Description of the Related Art

Generally, a glove box of a vehicle stores many items. A glove box is installed in the instrument panel of the passenger side.

When someone takes an item from the glove box, it is necessary to see the interior of the glove box in order to find the desired items received in the glove box. In this case, the interior of the glove box can be easily seen in the daytime, but in the nighttime, it is difficult to see the interior of the glove box.

In order to see the interior of the glove box, a dome light installed to a ceiling of a vehicle is turned on. However, since the distance between the dome light and the glove box is far, it is difficult to fully illuminate the interior the glove box using the dome light.

In order to solve this problem, a glove box lamp is installed within the glove box, and a switch is provided such that the lamp is turned on when a glove box door is opened. Accordingly, the glove box lamp is automatically turned on simultaneously with the opening of the glove box, thereby illuminating the interior of the glove box.

The switch for turning on the glove box lamp is positioned to contact the glove box door. When the glove box door is closed, the switch is turned off, thus turning the lamp off. When the glove box door is opened, the switch is turned on, thus turning the lamp on.

However, the glove box may be deformed by items stored in the glove box thus changing the position of the glove box lamp switch, which is in contact with the glove box door. Accordingly, there may be a problem in that the glove box lamp may be turned on even when the glove box door is not opened.

Furthermore, there may also be a problem on the glove box switch located on the glove box door. The items stored in the glove box may be shifted to one side of the glove box by a vehicle in motion even when the glove box is not deformed by the items, thus changing the glove box door and the glove box lamp switch. Accordingly, there may be a problem in that the glove box lamp may be turned on even when the glove box door is not opened.

Still furthermore, the glove box door which is in contact with the glove box lamp switch may also be changed by the repetitions of opening and closing operations of the glove box. Accordingly, there may be a problem in that the glove box lamp may be turned on even when the glove box door is not opened.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a glove box lamp switch turning on a glove box lamp in response to an opening of a glove box door even when a glove box of a vehicle is deformed.

Furthermore, the present invention provides a glove box lamp switch which constantly maintains contact with the glove box lamp even when items stored in the glove box are shifted to one side while a vehicle is in motion.

Still furthermore, the present invention provides a glove box lamp switch maintains contact with the glove box lamp even when opening and closing of the glove box are continuously repeated.

An exemplary embodiment of the present invention provides a glove box lamp switch that is installed to a glove box damper. The glove box damper includes an end which is connected to one side of an inner portion of an instrument panel and a damper piston is connected to one end of a glove box. The glove box damper is configured such that the total length varies depending on the opening and closing of the glove box. The glove box damper is filled with air so as to absorb an impact generated during opening and closing operations of the glove box of a vehicle. The glove box lamp includes a first terminal installed at one side of an interior of the damper cylinder and a second terminal formed in a semi-circular shape and installed to a stopping flange formed at one end of the damper piston, thereby selectively contacting the first terminal by a movement of the damper piston.

A projection hole may be formed at an end portion of the damper cylinder.

The first terminal may be installed to a portion of the damper cylinder opposite to a connecting point of the damper cylinder and the instrument panel.

The first terminal may be installed within the damper cylinder through an incision hole formed at an end portion of the damper cylinder.

The incision hole may be formed perpendicular to a center axis of the damper cylinder.

The first terminal may be formed by disposing a first contact terminal and a semicircular shaped second contact terminal in a line symmetry to which contact ends are respectively formed at end portions thereof.

The first and the second contact terminals may be connected to a center portion of an electric power line connected to the glove box lamp.

The second terminal may be installed at a side opposite to a connecting point of the damper piston and the glove box.

### BRIEF DESCRIPTION OF THE DRAWINGS

FIG. 1 is a drawing showing a glove box lamp switch according to an embodiment of the present invention.

FIG. 2 is an enhanced perspective view of a glove box lamp switch according to an embodiment of the present invention.

FIG. 3 is a cross-sectional view showing operations of glove box lamp switch according to an embodiment of the present invention by opening and closing of a glove box cover of a vehicle.

FIG. 4a and FIG. 4b are drawings showing operations of a glove box lamp switch according to an embodiment of the present invention.

FIG. 5 is a cross-sectional view of a glove box lamp switch according to an embodiment of the present invention.

### DETAILED DESCRIPTION OF THE EMBODIMENTS

An exemplary embodiment of the present invention will hereinafter be described in detail with reference to the accompanying drawings.

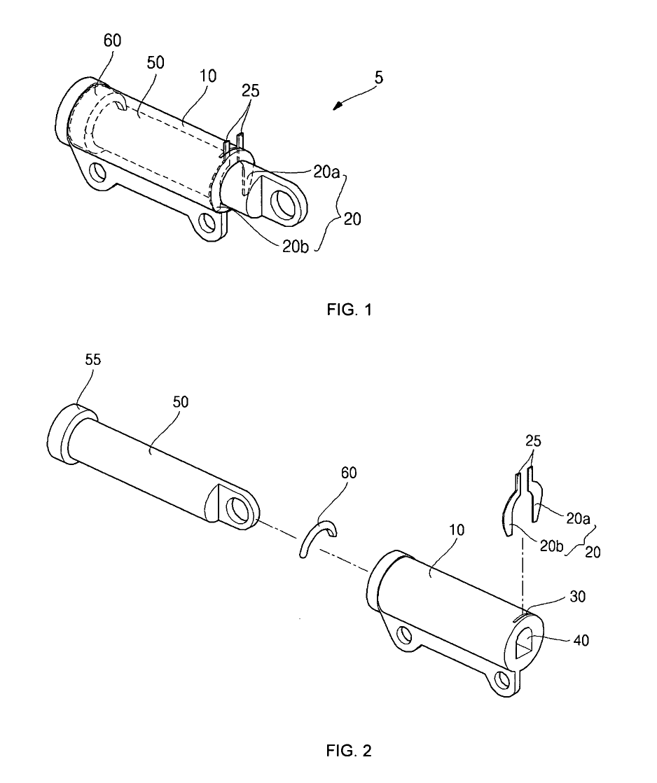

FIG. 1 is a drawing showing a glove box lamp switch according to an embodiment of the present invention. One end of a damper cylinder 10 is connected to one side of an inner portion of a glove box, and is configured such that the overall length varies according to opening and closing of the glove box. An inner space of the damper cylinder 10 is filled with air so that it absorbs impact generated during the opening and closing of the glove box. A first terminal 20 is installed to one end of an inner portion of the damper cylinder 10. A second terminal 60 is installed to one end of a damper piston 50, and selectively contacts the first terminal 20 by the movement of the damper piston 50.

The first terminal 20 may be installed at a side opposite to a connecting point of the damper cylinder 10 and the instrument panel.

The first terminal 20 is formed by disposing a first contact terminal 20a and a semicircular shaped second contact terminal 20b in a line symmetry, and contact ends 25 are respectively formed at end portions of the first and the second contact terminals 20a and 20b. The first terminal 20 may be connected to a center portion of an electrical power line connected to the glove box lamp. The first terminal 20 may be installed within the damper cylinder 10 through an incision hole 30 formed at an end portion of the damper cylinder 10.

The incision hole 30 may be formed in a direction perpendicular to the center axis of the damper cylinder 10.

The second terminal 60 may be installed at a position opposite to a connection point of the damper piston 50 and a glove box 1.

A projection hole 40 may be formed at one end portion of the damper cylinder 10.

The glove box lamp switch according to an embodiment of the present invention will now be explained in more detail with reference to the drawings.

A lamp is installed to the glove box, and the lamp is turned on so as to illuminate the interior of the glove box when the glove box is opened to put an item in or out of the glove box.

If a glove box door is abruptly opened, an impact may occur, which may damage the glove box door. In order to prevent the glove box door from being abruptly opened, a glove box damper 5 is installed at one side of a glove box 1 as shown in FIG. 1.

The glove box damper 5 includes the damper cylinder 10. A damper piston 50 is inserted into the damper cylinder 10 and move within the damper cylinder 10 in response to opening and closing of the glove box 1. At this time, the damper piston 50 protrudes out of the cylinder through a projection hole 40 formed at one end portion of the damper cylinder 10 as shown in FIG. 2.

Accordingly, one end of the damper cylinder 10 is connected to the inside portion of an instrument panel to which the glove box 1 is installed, and an end, which is opposite to an end inserted into the damper cylinder 10, of the damper piston 50 is connected to one side of the glove box 1.

At this time, connecting portions of the damper cylinder 10 and the damper piston 50 may be respectively connected by rotating axes, so that the damper piston 50 can be inserted smoothly into or drawn out from the damper cylinder 10 in response to opening and closing of the glove box.

The first terminal 20 is installed inside the damper cylinder 10. That is, an incision hole 30 is formed in a circumference of the damper cylinder 10 opposite to the connecting point of the damper cylinder 10 and the instrument panel is perpendicular to a center axis of the damper cylinder 10. The first terminal 20 is formed by disposing the first and the second contact terminals 20a and 20b of a semicircular shape in a line symmetry to which the contact ends 25 are respectively formed at end portions and are inserted into the incision hole 30, so that the first terminal 20 is disposed inside one end of the damper cylinder 10.

The second terminal 60 is selectively contacted with the first terminal 20 which is installed at one end portion of the damper piston 50. The damper piston 50 is shown in FIG. 2. A stopping flange 55 is formed at one end of the damper piston 50. The stopping flange 55 prevents the damper piston 50 from being completely taken out from the damper cylinder 10 when the damper piston 50 moves within the damper cylinder 10. At this time, the second terminal 60 has a semicircular shape and is installed at the stopping flange 55, such that the second terminal 60 contacts the first terminal 20 when the stopping flange 55 is maximally moved to the end of the damper cylinder 10.

An inner space of the damper cylinder 10 is filled with fluid such as compressible air or oil. Accordingly, when a sudden impact acts on the damper piston 50, the impact is dampened by the operation of the fluid so that the damper piston 50 may move slowly.

The first and the second terminals 20 and 60 are respectively formed in the damper cylinder 10 and the damper piston 50 contact each other by the movement of the damper piston 50. The first terminal 20 is connected to the center portion of the electric power line through which electric power is applied to the glove box lamp. If the first and the second terminals 20 and 60 contact each other as to be electrically connected to each other, the electric power supplied from the outside is applied to the glove box lamp thereby illuminating the glove box lamp.

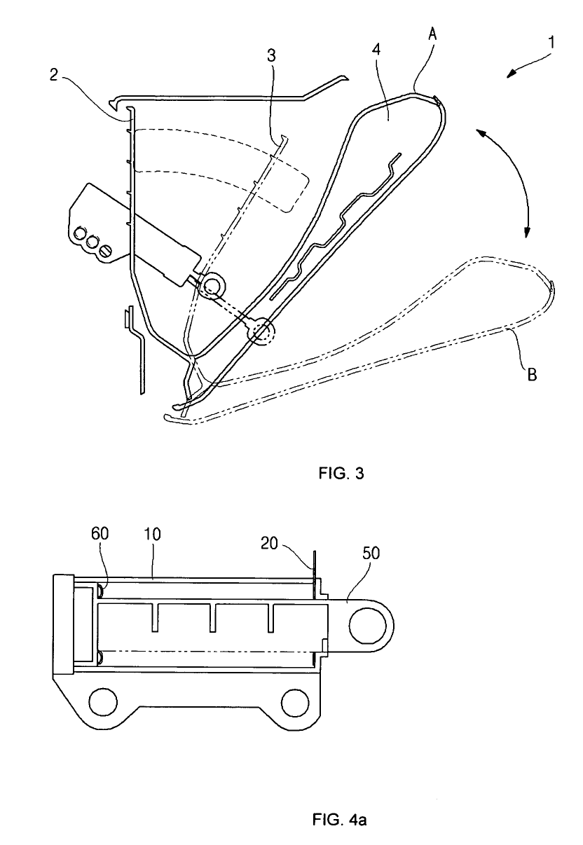

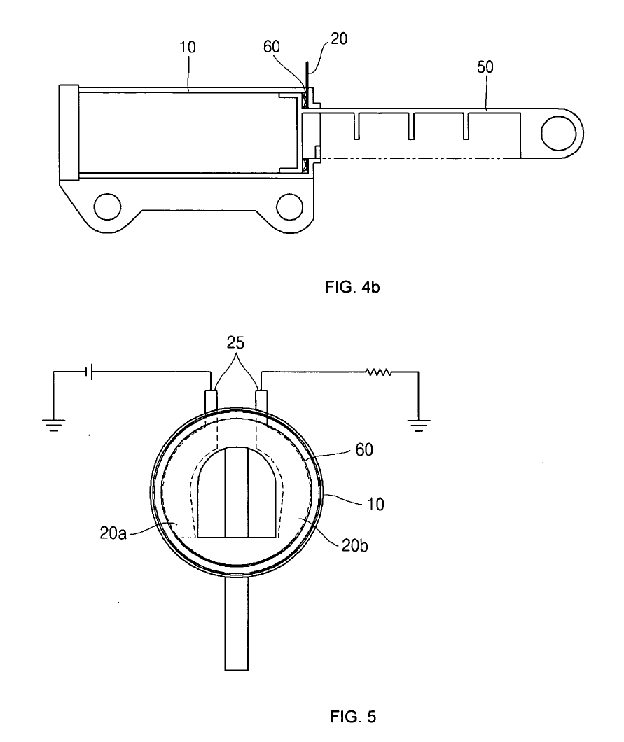

Accordingly, when the glove box is closed as shown in state A of FIG. 3, the damper cylinder 10 and the damper piston 50 are positioned as shown in FIG. 4a. Since, the first and the second terminals 20 and 60 do not contact each other, the glove box lamp is turned off.

If the glove box is opened, the damper piston 50 is disposed within the damper cylinder 10 moves linked with opening of the glove box 1. If the glove box 1 is completely opened as shown in state B of FIG. 3, the damper cylinder 10 and the damper piston 40 are located such that the glove box damper 5 fully protrudes from one side of the damper cylinder 50 as shown in FIG. 4b, thereby allowing the first and the second terminals 20 and 60 to contact each other.

If an electric power is supplied through the first and the second terminals 20 and 60, the glove box lamp is turned on, thereby illuminating the interior of the glove box. Accordingly, a user can easily find a desired item within the glove box.

The glove box lamp switch has an effect on the glove box lamp being reliably turned on even when the glove box is opened and the glove box is deformed by too many items therein.

Furthermore, even when items stored in the glove box are gathered together to one side while a vehicle is in motion, the contact state of the switch may be constantly maintained, thus allowing the glove box lamp to be turned on when the glove box is opened.

Still furthermore, even when opening and closing operations of the glove box are continuously repeated, the contact state of the glove box and the switch is constantly maintained, thus allowing the glove box lamp to be turned on when the glove box is opened.

What is claimed is:

1. A glove box lamp switch that is installed to a glove box damper including a damper cylinder at an end of which is connected to one side of an inner portion of an instrument panel and a damper piston is connected to one end of a glove box, the glove box damper is configured such that a total length varies depending on opening and closing of the glove box and being filled with air so as to absorb an impact generated during opening and closing operations of the glove box of a vehicle, the glove box lamp switch comprising:
a first terminal installed at a first side of an interior of the damper cylinder; and
a semicircular shaped second terminal which is installed to a stopping flange formed at a first end of the damper piston and selectively contacting the first terminal by movement of the damper piston.

2. The glove box lamp switch of claim 1, wherein a projection hole is formed at a first end portion of the damper cylinder.

3. The glove box lamp switch of claim 1, wherein the first terminal is installed to a portion of the damper cylinder opposite to a connecting point of the damper cylinder and the instrument panel.

4. The glove box lamp switch of claim 3, wherein the first terminal is installed within the damper cylinder through an incision hole formed at an end portion of the damper cylinder.

5. The glove box lamp switch of claim 4, wherein the incision hole is perpendicular to the center axis of the damper cylinder.

6. The glove box lamp switch of claim 1, wherein the first terminal is formed by disposing a first contact terminal and a semicircular shaped second contact terminal in a line symmetry shape to which contact ends are respectively formed at end portions.

7. The glove box lamp switch of claim 6, wherein the first and the second contact terminals are connected to a center portion of an electric power line which is connected to the glove box lamp.

8. The glove box lamp switch of claim 1, wherein the second terminal is installed at a side opposite to a connecting point of the damper piston and the glove box.
